(19) United States
(12) Patent Application Publication
(10) Pub. No.: US 2010/0332327 A1
(43) Pub. Date: Dec. 30, 2010

(54) Advertisement consumer system for a mobile communications device

(75) Inventor: Ming-Shun Yu, Longtan Township (TW)

Correspondence Address: Muncy, Geissler, Olds & Lowe, PLLC, 4000 Legato Road, Suite 310, FAIRFAX, VA, 22033, US

(73) Assignee: A-Men Technology Corporation

(21) Appl. No.: 11/976,597

(22) Filed: Oct. 25, 2007

(51) Int. Cl. G06Q 30/00; H04W 4/12

(52) U.S. Cl. 705/14.64; 455/466; 705/14.4

(57) ABSTRACT

The present invention relates to an advertisement consumer system for a mobile communications device, which includes a mobile communications device and a sensor marker, and the mobile communications device is linked to a preset electronic consumer system. The mobile communications device and the sensor marker transmit commercial messages by means of wireless radio frequency transceivers. Accordingly, recently received transaction messages can be referenced directly from the mobile communications device and within the user interface, which can be used to transmit the transaction message when wanting to execute a consumer transaction. Hence, the user can instantaneously learn of special discount news or related preferential benefits on all kinds of commodities, products or commercial activities at any time, thereby expediting the convenience of executing consumer transactions for the user, while companies or suppliers can save on the cost of advertising and use the sensor marker to achieve more extensive advertising effectiveness.

### BACKGROUND OF THE INVENTION

(a) Field of the Invention

The present invention relates to an advertisement consumer system, and more particularly to an advertisement consumer system for a mobile communications device which enables a mobile communications device to download advertisement content at any time and execute consumer transactions based on the advertisement content.

(b) Description of the Prior Art

The advertisement is the most important key factor in the marketing of products and commercial activities, and advertisement methods can be clearly divided into planar advertisements or multimedia advertisements, with planar advertisements having the longest history and most widespread use.

The great variety of planar advertisements include catalogs, advertisement signboards, advertisement billboards, promotional literature, and so on, and the locations where planar advertisement are used are widespread and omnipresent, such as buses, sidewalks, walls, and so on. Hence, the effectiveness of planar advertisements can be exceptional and astonishing.

Furthermore, after seeing the advertisements, the objective of advertisements is to attract and leave an impression on the consumer regarding the commercial activities in the advertisements, and to convince the consumer to execute a consumer transaction. For example, a movie advertisement wants to inform the consumer the name of the movie, the time when the movie will be screened, the theater and the actors, and then prompt the consumer to purchase tickets through the telephone, the Internet or at the movie theater. Moreover, advertisements inform consumers about the unique features, effectiveness, ingredients, spokesperson, and so on, of the food or commodity, and then attracts the consumer to a store to purchase the food or commodity.

However, following technological progress, apart from planar advertisements, the consumer also receives many commercial advertisements via the mobile phone, the computer, and the like, after which the consumer is able to use the telephone to carry out voice shopping or connect to the shopping website of the company to shop online.

However, the aforementioned various shopping methods are unable to effectively increase the sales performance of companies or suppliers, and, furthermore, are unable to satisfy the spending desires of consumers. More particularly, the inventor of the present invention and manufacturers engaged in related art propose to resolve and surmount existent technical difficulties to provide an advertisement consumer system for a mobile communications device that allows the omnipresent planar advertisements to enable the consumer to instantly place a purchase order after seeing the planar advertisement without the need for additional devices or equipment and still achieve the aforementioned effectiveness.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements has designed a new advertisement consumer system for a mobile communications device of the present invention which enables a mobile communications device to download advertisement content at any time and execute consumer transactions based on the advertisement content.

A primary objective of the present invention is to provide a mobile communications device and a sensor marker respectively configured with a wireless radio frequency transceiver, wherein the wireless radio frequency transceiver of the sensor marker stores commercial messages. When the wireless radio frequency transceiver of the mobile communications device senses the sensor marker and receives the commercial message from the sensor marker, then a user interface of the mobile communications device stores the received commercial message as a new transaction message, whereupon the user is able to learn of the recently received transaction messages from the user interface. Furthermore, a user is able to use the user interface to select the desired transaction message he wishes to execute as a consumer transaction, and transmit the transaction message to an electronic consumer system using the mobile communications device. The electronic consumer system then notifies the corresponding company or supplier based on the content of the transaction message, thereby enabling the company or supplier to provide the consumer the corresponding commercial activity. Accordingly, the user can instantaneously learn of special discount news or related preferential benefits on all kinds of commodities, products or commercial activities at any time, and thereby expedite the convenience of executing consumer transactions for the user. At the same time, companies or suppliers can save on the cost of advertising, and use the sensor marker to achieve more extensive advertising effectiveness.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a block diagram of a preferred embodiment according to the present invention.

FIG. 2 shows flow chart 1 of the preferred embodiment according to the present invention.

FIG. 3 shows flow chart 2 of the preferred embodiment according to the present invention.

FIG. 4 shows a block diagram of another preferred embodiment according to the present invention.

### DETAILED DESCRIPTION OF THE PREFERRED EMBODIMENTS

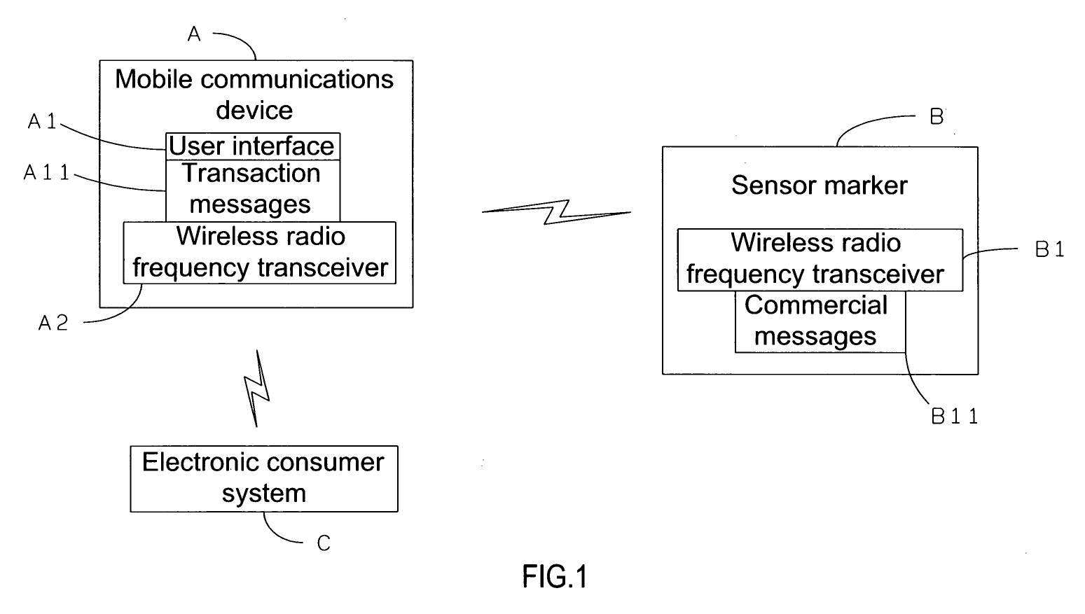

Referring to FIG. 1, which shows a block diagram of a preferred embodiment of the present invention, and it can be seen from the drawing that the present invention comprises a mobile communications device A and a sensor marker B, and the mobile communications device A is linked to a preset electronic consumer system C, wherein:

the mobile communications device A is configured with a wireless radio frequency transceiver A2 and a user interface A1 which stores transaction messages A11. Moreover, the user interface A1 is able to transmit the transaction messages A11 to the electronic consumer system C, and the user interface A1 can be a hardware, software or firmware configuration residing in the mobile communications device A. When the user interface A1 is a hardware configuration, then the wireless radio frequency transceiver A2 can be joined thereto to form an integrated circuit and attached to a SIM card (Subscriber Identity Module Card) of the mobile communications device A. Moreover, when the user interface A1 is a firmware configuration, then it can be burned into a SIM card of the mobile communications device A, or burned into the integrated circuit of the mobile communications device A. When the user interface A1 is a software configuration, then it can be embedded into the operating system of the mobile communications device A. In addition, the mobile communications device A can be a mobile phone, a PDA (Personal Digital Assistant) or a notebook computer.

The sensor marker B is configured with a wireless radio frequency transceiver B1, and at least one or more than one commercial messages B11 is preinstalled within the wireless radio frequency transceiver B1. Moreover, because the sensor marker B is a micro integrated circuit form it can be installed to planar advertisements, including advertisement billboards, advertisement catalogs, vehicle advertisements, product catalogs, and the like. Furthermore, the sensor marker B configured as a micro integrated circuit enables it to be attached to planar advertisements using attachment means such as label sticking.

Furthermore, the communication means adopted between the aforementioned electronic consumer system C and the mobile communications device A can be either GSM (Global System for Mobile communication), CDMA (Code Division Multiple Access), PHS (Personal Hand-phone System), GPRS (General Packet Radio Service), WiFi (Wireless Fidelity) or beyond third generation mobile communication systems.

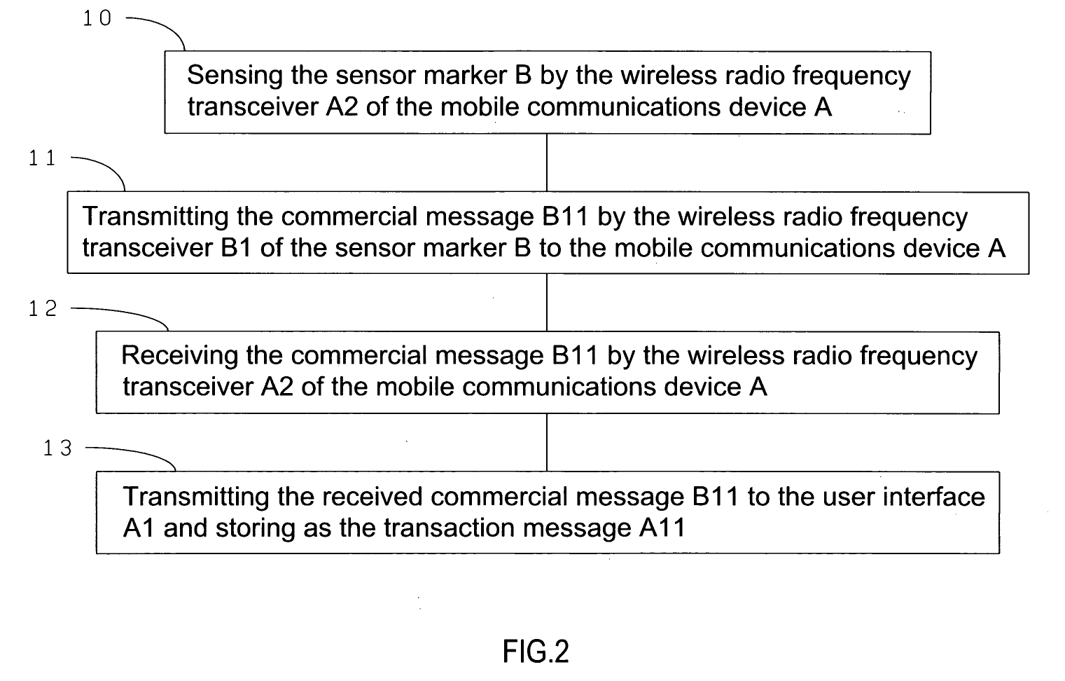

Referring to FIG. 1 together with FIG. 2, which depict the block diagram and a flow chart 1 respectively of the preferred embodiment of the present invention, and it can be seen from the drawings that after the mobile communications device A receives the commercial message B11, then the following steps are implemented:

(10) Sensing the sensor marker B by the wireless radio frequency transceiver A2 of the mobile communications device A;

(11) Transmitting the commercial message B11 by the wireless radio frequency transceiver B1 of the sensor marker B to the mobile communications device A;

(12) Receiving the commercial message B11 by the wireless radio frequency transceiver A2 of the mobile communications device A;

(13) Transmitting the received commercial message B11 to the user interface A1 and storing as the transaction message A11.

When executing the aforementioned steps, the wireless radio frequency transceiver A2 of the mobile communications device A senses the sensor marker B and reads the commercial message B11 in the sensor marker B, at which time, the wireless radio frequency transceiver B1 of the sensor marker B transmits the commercial message B11 to the mobile communications device A. After the wireless radio frequency transceiver A2 of the mobile communications device A receives the commercial message B11, then the received commercial message B11 is transmitted to the user interface A1, and the user interface A1 stores the received commercial message B11 as the new transaction message A11, whereupon the user is able to learn of the recently received transaction messages A11 from the user interface A1.

The aforementioned wireless radio frequency transceivers A2 and B1 can be further configured as Bluetooth signal transceivers, infrared signal transceivers or short distance wireless signal transceivers, and used to transmit the commercial message B11.

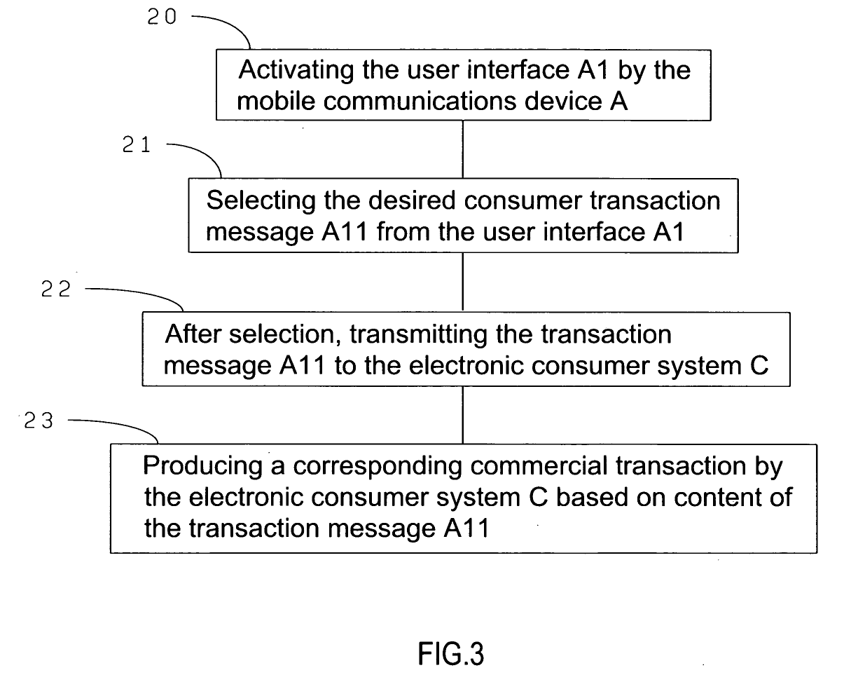

Referring to FIG. 1 together with FIG. 3, which depict the block diagram and a flow chart 2 respectively of the preferred embodiment of the present invention, and it can be seen from the drawings that when the mobile communications device A is used to execute an electronic consumer transaction, then the following steps are implemented:

(20) Activating the user interface A1 by the mobile communications device A;

(21) Selecting the desired consumer transaction message A11 from the user interface A1;

(22) After selection, transmitting the transaction message A11 to the electronic consumer system C;

(23) Producing a corresponding commercial transaction by the electronic consumer system C based on content of the transaction message A11.

When executing the aforementioned steps, the mobile communications device A activates the user interface A1, whereupon the user is able to browse all the transaction messages A11 using the user interface A1 of the mobile communications device A, and after the user selects the desired transaction message A11 he wishes to execute as a consumer transaction, then the mobile communications device A transmits the transaction message A11 to the electronic consumer system C via SMS (Short Message Service), MMS (Multimedia Message Service) or EMS (Enhanced Message Service) means. The electronic consumer system C receives the transaction message A11 and notifies the corresponding company or supplier based on the content of the transaction message A11, thereby enabling the company or supplier to provide the consumer the corresponding commercial transaction.

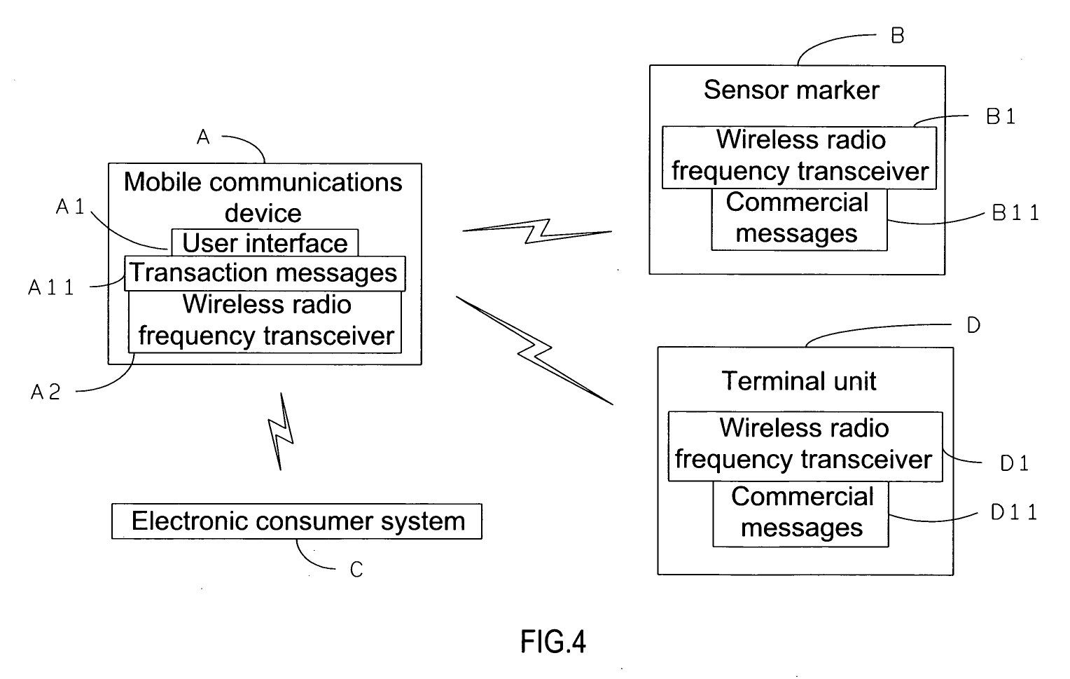

Referring to FIG. 4, which shows a block diagram of another preferred embodiment of the present invention, and it can be seen from the drawing that the present invention further comprises a terminal unit D, within which is configured a wireless radio frequency transceiver D1. The wireless radio frequency transceiver D1 is preinstalled with at least one or more than one commercial message D11, and the wireless radio frequency transceiver D1 can actively continually outwardly transmit the commercial messages D11. After the wireless radio frequency transceiver A2 of the mobile communications device A senses the commercial messages D11, then the received commercial messages D11 are transmitted to the user interface A1, and the user interface A1 stores the received commercial messages D11 as new transaction messages A11, whereupon the user is able to learn of the recently received transaction messages A11 from the user interface A1.

The aforementioned terminal unit D can be either a cash register, an ATM (Automatic Teller Machine), a prepaid card add value machine, a vending machine or an electronic machine having a terminal operable by a user. In addition, the aforementioned wireless radio frequency transceivers A2 and D1 can be further configured as Bluetooth signal transceivers, infrared signal transceivers or short distance wireless signal transceivers, and used to transmit the commercial message D11.

Hence, with reference to all the attached drawings, the key factors that enable the mobile communications device A for an advertisement consumer system of the present invention to improve on the prior art are described as follows:

1. When the user is carrying the mobile communications device A, and discovers the sensor marker B attached to a planar advertisement, such as an advertisement billboard, an advertisement catalog, a vehicle advertisement, a product catalog, and the like, or discovers that the mobile communications device A has received the new transaction message A11, then the new transaction message A11 can be referenced directly from within the user interface A1. Moreover, the user interface A1 can be used to transmit the transaction message A11 when wanting to execute a consumer transaction. Hence, the user can instantaneously learn of special discount news or related preferential benefits on all kinds of commodities, products or commercial activities at any time, and thereby expedite the convenience of executing consumer transactions for the user.

2. The transaction messages A11 can be exchanged between the mobile communications device A of different users via the wireless radio frequency transceiver A2 built into the mobile communications device A. Hence, sharing of knowledge gained and recommendation on consumer transactions between users imperceptibly improves the sales performance of companies or suppliers.

3. Companies or suppliers may freely set up the sensor marker B, and because the sensor marker B is a micro integrated circuit form it can be further attached to paper labels to achieve effectiveness of small size, light weight, thinness and convenient disposition. Hence, companies or suppliers can save on advertising costs, and at the same time can use the sensor marker B to achieve more extensive advertising effectiveness.

In conclusion, the advertisement consumer system for a mobile communications device of the present invention is clearly able to achieve effectiveness and objectives when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An advertisement consumer system for a mobile communications device, comprising a mobile communications device and a sensor marker, the mobile communications device is linked to a preset electronic consumer system, wherein:
the sensor marker is configured with a wireless radio frequency transceiver, and at least one or more than one commercial message is preinstalled within the wireless radio frequency transceiver;
the mobile communications device is configured with a wireless radio frequency transceiver able to receive commercial messages and a user interface able to store the commercial messages as transaction messages, the user interface is able to transmit the transaction messages to the electronic consumer system.

2. The advertisement consumer system for a mobile communications device according to claim 1, wherein the sensor marker is a micro integrated circuit form, and is installed to planar advertisements, including advertisement billboards, advertisement catalogs, vehicle advertisements, product catalogs, and the like.

3. The advertisement consumer system for a mobile communications device according to claim 1, wherein the sensor marker is a micro integrated circuit label form attached to a planar advertisement.

4. The advertisement consumer system for a mobile communications device according to claim 1, wherein the user interface of the mobile communications device transmits transaction messages via either SMS (Short Message Service), MMS (Multimedia Message Service) or EMS (Enhanced Message Service).

5. The advertisement consumer system for a mobile communications device according to claim 1, wherein the user interface is a hardware, software or firmware configuration residing in the mobile communications device.

6. The advertisement consumer system for a mobile communications device according to claim 5, wherein when the user interface is a hardware configuration, then the user interface is an integrated circuit form attached to a SIM card (Subscriber Identity Module Card) of the mobile communications device.

7. The advertisement consumer system for a mobile communications device according to claim 5, wherein when the user interface is a firmware configuration, then the user interface is burned into a SIM card of the mobile communications device, or burned into the integrated circuit of the mobile communications device.

8. The advertisement consumer system for a mobile communications device according to claim 5, wherein when the user interface is a software configuration, then the user interface is embedded into the operating system of the mobile communications device.

9. The advertisement consumer system for a mobile communications device according to claim 6, wherein the user interface of the hardware configuration is joined to a wireless radio frequency transceiver.

10. The advertisement consumer system for a mobile communications device according to claim 1, wherein the mobile communications device is a mobile phone, a PDA (Personal Digital Assistant) or a notebook computer.

11. The advertisement consumer system for a mobile communications device according to claim 1, wherein the following steps are implemented when the mobile communications device receives commercial messages:
sensing the sensor marker by the wireless radio frequency transceiver of the mobile communications device;
transmitting the commercial message by the wireless radio frequency transceiver of the sensor marker to the mobile communications device;
receiving the commercial message by the wireless radio frequency transceiver of the mobile communications device;
transmitting the received commercial message to the user interface and storing as the transaction message.

12. The advertisement consumer system for a mobile communications device according to claim 1, wherein the following steps are implemented when the mobile communications device executes an electronic consumer transaction:
activating the user interface by the mobile communications device;
selecting the desired consumer transaction message from the user interface;
after selection, transmitting the transaction message to the electronic consumer system:
producing a corresponding commercial transaction by the electronic consumer system based on content of the transaction message.

13. The advertisement consumer system for a mobile communications device according to claim 1, further comprising a terminal unit, and the terminal unit is configured with a wireless radio frequency transceiver, the wireless radio frequency transceiver is preinstalled with at least one or more than one commercial message, and the wireless radio frequency transceiver actively continually outwardly transmits the commercial messages.

14. The advertisement consumer system for a mobile communications device according to claim 13, wherein the terminal unit is a cash register, an ATM (Automatic Teller Machine), a prepaid card add value machine, a vending machine or an electronic machine having a terminal operable by a user.

15. The advertisement consumer system for a mobile communications device according to claim 1, wherein the wireless radio frequency transceiver of the electronic device is further configured either as a Bluetooth signal transceiver, an infrared signal transceiver or a short distance wireless signal transceiver.

16. The advertisement consumer system for a mobile communications device according to claim 1, wherein the wireless radio frequency transceiver of the sensor marker is further configured either as a bluetooth signal transceiver, an infrared signal transceiver or a short distance wireless signal transceiver.

17. The advertisement consumer system for a mobile communications device according to claim 13, wherein the wireless radio frequency transceiver of the terminal unit is further configured either as a Bluetooth signal transceiver, an infrared signal transceiver or a short distance wireless signal transceiver.

18. The advertisement consumer system for a mobile communications device according to claim 1, wherein the communication means adopted between the electronic consumer system and the mobile communications device is either GSM (Global System for Mobile communication), CDMA (Code Division Multiple Access), PHS (Personal Hand-phone System), GPRS (General Packet Radio Service), WiFi (Wireless Fidelity) or beyond third generation mobile communication systems.
